(19) United States
(12) Patent Application Publication
(10) Pub. No.: US 2015/0052390 A1
(43) Pub. Date: Feb. 19, 2015

(54) Apparatus and Method for Microprocessor File System Protection

(71) Applicants: JOHN DAVID LAMBERT, KATY, TX (US); JOSEPH ERNEST DRYER, HOUSTON, TX (US); IAN JAMES LAMBERT, KATY, TX (US)

(72) Inventors: JOSEPH ERNEST DRYER, HOUSTON, TX (US); JOHN DAVID LAMBERT, KATY, TX (US); IAN JAMES LAMBERT, KATY, TX (US)

(73) Assignee: BREAKAWAY SYSTEMS, HOUSTON, TX (US)

(21) Appl. No.: 13/966,043

(22) Filed: Aug. 13, 2013

(51) Int. Cl. G06F 1/30; G06F 11/14

(52) U.S. Cl. CPC G06F 1/30; G06F 11/1441; G06F 11/2015
USPC 714/14

(57) ABSTRACT

A system for providing protection to a processor system from the problems associated with power failures in the middle of processor operations is described. On detection of a power failure in the main power source, the processor power is maintained by means of a short-term secondary power source. Either immediately or after a momentary pause to override glitches, if power remains off the processor is notified that power will soon be removed and that an orderly shutdown is to take place. Once the protected system has completed its orderly shutdown, or after a length of time indicating that the orderly shutdown is improbable, power is removed from the system for a defined period and the system removes power from the protected processor system for at least a defined period of time, providing an assured hard restart. When external power is restored a normal running state is resumed after any power up sequencing. The orderly shutdown and hard reset can take place by command from the protected processor or system. A state machine is used to sequence the states in this process and control the transitions between states.

### CROSS-REFERENCE TO RELATED APPLICATIONS

None

### FEDERALLY SPONSORED RESEARCH

None.

### SEQUENCE LISTING

None.

### BACKGROUND

### Prior Art

The following is a tabulation of some prior art that presently appears relevant:

U.S. Patents

| | | |
|---|---|---|
| 5,748,972 | May 5, 1998 | Clark, et al. |
| 6,230,181 | May 8, 2001 | Mitchell, et al. |
| 6,274,949 | Aug. 14, 2001 | Lioux, et al. |
| 6,538,344 | Mar. 25, 2003 | Yang, et al. |
| 7,296,165 | Nov. 13, 2007 | Feldstein, et al. |
| 7,296,171 | Nov. 13, 2007 | Hahn, et al. |
| 7,385,435 | Jun. 10, 2008 | Pham, et al. |
| 8,117,465 | Feb. 14, 2012 | Wu, et al. |
| 8,495,406 | Jul. 23, 2013 | Hutchison, et al. |

### TERMINOLOGY

In the following discussion the terms processor and microprocessor will be used interchangeably to represent a general processing machine. Some additional examples of such a general processing machine can also include PGAs, microprocessors, microcontrollers and CPUs,

A hard restart refers to the sequence of removing power from the system for a fixed time and reapplying power, as opposed to a soft reset where the system reset line is activated or a software reset is triggered while power remains applied.

A state machine is considered to be any implementation of a finite-state or infinite-state machine by which a sequence of operations can be carried out to transition from one state (e.g. normal operation) to another state (e.g. shutdown) by means of defined operations in response to an external stimulus (e.g. power failure). The state machine can be implemented, for example, by a microprocessor, a PGA, PAL, PLA or a memory.

An orderly shutdown of a system would provide all operations necessary to prepare the system in a safe manner for the removal of power, including the closing of all open files, synchronization of file systems, termination of write operations, and possibly operation out of RAM. It also could include nonvolatile logging of the time of the shutdown and any information that could be useful to diagnose the cause of such shutdown. The protected processor system could also communicate to the outside world that it is shutting down as part of its orderly shutdown.

Shutdown period is the time span required for an orderly shutdown of the protected processor system. This will depend on many factors such as the processor, the processor clock, and the software complexity. Some systems will require an orderly shutdown of peripherals which must be monitored by the protected processor to insure that their shutdown is complete before the protected processor declares that an orderly shutdown is completed. Normally this shutdown period should not extend past some tens of seconds as the described protection system is not intended for performing the function of a UPS to maintain normal operation, but rather to only facilitate an orderly shutdown. The maximum shutdown time is, for a given system, the longest period that will allow shutdown under any conditions expected to be encountered. The shutdown period is considered to be the actual shutdown time or the maximum shutdown period, whichever is shortest, in order to allow for isolated cases where some form of system lockup is encountered threatening that the system may never achieve an orderly shutdown.

### BACKGROUND

A common problem in microprocessor systems is a corruption of the file system during unexpected power interruptions. Even with a journaling file system this problem presents itself in garbled writes caused by fluctuating power or by inherent instabilities in flash devices. Tseng et. al have shown that power failure during read, write or erase operations on flash memories significantly increases subsequent read and write errors to the same block, with many such errors difficult to detect (http://cseweb.ucsd.edu/users/swanson/papers/DAC2011PowerCut.pdf). While a UPS can correct this problem the added cost, complexity, size and UPS reliability issues cause additional problems. In addition, UPS systems utilizing energy storage systems such as a battery must eventually fail if the input power is disconnected for an extended period of time, possibly leading to an uncontrolled shutdown. The holdup time of power supplies (the duration between the removal of the power supply input power and the loss of the power supply output power) is often in the millisecond range and gives insufficient warning of an impending power failure to allow an orderly closure of file systems within the system. An operating system often contains a virtual file system in volatile memory which may be several tens or even hundreds of megabytes depending on availability. To minimize data loss this must be flushed to non-volatile memory. Low cost solid state devices often have transfer speeds of less than 10 MBytes/s Therefore the maximum shutdown time can be tens of seconds. Note that this is a matter of insuring file system integrity, not saving the processor state, which is not a topic of this invention. A UPS is designed to maintain the system power and allow for normal operation during the UPS backup period.

Embedded systems are normally designed for remote operation and often in critical operations where the consequences of the failure to perform are severe and the servicing of such problems are expensive, putting a premium on avoiding the reliability problems described above.

Early computers were large enough and expensive enough that power backup was a small system consideration. The advent of the personal computer (PC) raised new system reliability issues due to power outages. Often the lengthy startup times suggested that the operational state should be preserved and startup resumed from the computer state as it existed at shutdown. A notable example of addressing this problem was U.S. Pat. No. 5,748,972 by Clark, et al. which addressed power interruption to a PC by including an internal power source and a “suspend state” for computer operation. This “suspend state” is described in the two independent claims as “wherein said suspend state is characterized by the code executing on the CPU being reversibly interrupted such that the execution of the code on the CPU is capable of being resumed” and “wherein said change from said normal operating state to said suspend state comprises transferring the memory data from said volatile memory to said non-volatile storage device and transferring the register data from the volatile registers to said non-volatile storage device”. The intent of the can be seen from the discussion: “The third state is the suspend state. In the suspend state, computer system consumes an extremely small amount of power. The suspended computer consumes very little power from the wall outlet. The only power consumed is a small amount of power to maintain the circuitry that monitors the switch from a battery inside the computer system (when the system is not receiving AC power) or a small amount of power generated at an auxiliary power line by the power supply (when the system is receiving AC power).

This small use of power is accomplished by saving the state of the computer system to the fixed disk storage device (the hard drive) before the power supply is turned “off.” To enter the suspend state, the computer system interrupts any executing code and transfers control of the computer to the power management driver. The power management driver ascertains the state of the computer system and writes the state of the computer system to the fixed disk storage device. The state of the CPU registers, the CPU cache, the system memory, the system cache, the video registers, the video memory, and the other devices' registers are all written to the fixed disk. The entire state of the system is saved in such a way that it can be restored without the code applications being adversely affected by the interruption. The computer then writes data to the non-volatile CMOS memory indicating that the system was suspended. Lastly, the computer causes the power supply to stop producing power. The entire state of the computer is safely saved to the fixed disk storage device, system power is now “off,” and computer is now only receiving a small amount of regulated power from the power supply to power the circuitry that monitors the switch.”

In other words the approach in U.S. Pat. No. 5,748,972 and similar approaches is to respond to a power failure by retaining all operational parameters which allow for a rapid resumption of operation when power is restored, which is fundamentally different from executing a normal shutdown, does not address the closing and synchronization of file systems, and entails additional writes to flash memories exasperating flash stress during power failure. The explanation of power resumption specifies “when leaving the suspend state 154, the computer 10 resumes executing where it was when it was interrupted.”

A fundamental change has taken place with the increased use of embedded systems with flash memories. While PC systems mainly used rotating disk memories, embedded systems have more often use flash memories. This especially raises new issues with the use of SD cards which have independent internal asynchronous memory controllers which are more difficult to safely shut down in short periods. The read/write errors observed in flash during power failure are also not present in rotating disk memories.

Most PC system approaches had a similar requirement for backing up pertinent data from the protected processor before shutdown. The following patents are among those that discuss controlling computer shutdown and restart while requiring some storage of the computer state before shutdown: U.S. Pat. Nos. 7,296,171, 8,495,406, 7,296,165, 8,117,465, 5,748,972, 6,274,949, 6,538,344, 8,117,465. In many previous patents (e.g. U.S. Pat. Nos. 7,385,435, 7,296,171, and 6,274,949) the processors are left in a suspended sleep state rather than being completely shut down in order to facilitate faster restart and limit data loss. While in many cases state storage and sleep states are desirable, in many systems they are unnecessary and even undesirable. It is to the latter cases that this invention is addressed.

### SUMMARY OF THE INVENTION

A protection system for processors is described for communicating with a protected processor system that a power shutdown is imminent, for maintaining the power until an orderly shutdown of the protected processor is complete and for providing a defined complete shutdown and subsequent orderly restoring of power. In case of a failing main power supply the protection system sources current from a backup power source to the protected processor system to keep the protected processor's voltage from dropping below the operating range of a protected processor. system. Such a failing main power supply is detected and the protection system communicates to the protected processor that the power will be lost and then waits for a communication from the protected processor that the orderly shutdown is completed. Once this shutdown is started the shutdown is irreversible even if the main power supply resumes operation. When the signal from the protected processor indicating completion of the orderly shutdown is received, or a maximum shutdown period has expired, all power to the protected processor is removed for a fixed time in order to insure a hard system reset. At the conclusion of this power removal time power is reapplied in an orderly manner from the main power supply either immediately if the power supply has resumed operation or at such time as the power supply resumes operation.

This system backup and processor handshaking is different from the functionality of a UPS in that while the UPS is designed to maintain operation, the described protection system is designed to shut down operation as soon as it is possible in order to insure that an orderly shutdown is achieved, with as little energy storage requirement as possible and with an insured duration off state and can include additional steps necessary to insure eventual restarting in a known state. As the desired outcome of a main power supply failure is a defined complete shutdown once no file corruption is ensured, followed by a normal restart after insuring a normal off period, there is no need to store any system state prior to the shutdown. The protection system can also include the ability to execute such controlled shutdown and hard reset when requested by the protected system.

Control of this protection system is supplied by a state machine such as a processor, discreet logic or equivalent such a PLA, gate array or memory independent of the protected processor. The state machine must be powered in such a manner so as to be able to operate when input power is not present, e.g. from the backup power source. The power backup need not be large as it only supports operation for tens of seconds and can be sourced from batteries, capacitors or any such energy storage device.

### ADVANTAGES

The system allows a safe shutdown to insure system integrity. The limited hold-up time (tens of seconds) allows the use of a much smaller energy storage reducing cost and size. The limited requirements of the state machine controlling the shutdown facilitates programmatic reliability. The removal of any requirement for immediate shutdown allows for the nonvolatile logging of as much data as is known about the shutdown times and possible cause as part of the orderly shutdown. If the protected processor is part of a larger protective system the imminent failure can be communicated to the outside world so that this can be considered in the larger system and remedial action can be initiated.

The ability for the protected processor to undergo a defined hard restart allows corrections of conditions that could not be corrected by a software reset. The inventors have encountered cases where system resets could not correct NIC and USB controller faults which could be cleared when power was removed and reasserted. Problems that require a hard reset could be due to programming errors in the implementation of the reset (e.g. an assumption that peripherals have their power-up default configuration) or hardware faults. When the protected processor encounters conditions that have been found to require a power cycling, the ability of the protected system to request a hard restart from the protection system provides a well-defined power cycling as a means for ensuring an orderly shutdown and a defined restart to clear such faults.

Insuring during a hard restart that the system undergoes an off period for a defined time even if input power is earlier restored avoids the problems that can arise from very brief power disruptions that allow system power to droop to unreliable levels before being restored to proper operating levels. This power droop can leave no trace other than improper operation. Often such power droops will not trigger power-on-reset (POR) systems.

This system allows an optional connection to the protected processor to allow the state machine to assume the watchdog function to restart the protected processor on watchdog “petting” failure through a hard restart which is preferred to a software reset in many conditions. This ability to accomplish a hard restart allows correction of conditions that might not be otherwise corrected, such as a peripheral hang. The hard restart can be preceded by the hand-shaking similar to that initiated by a power failure to insure the shutdown prior to the restart is orderly. Optionally an abnormally fast repetition of the watchdog petting by the protected processor can be used as a communication to this protection system that the protection system should initiate a hard restart or to recover from a tight loop which includes petting of the watchdog.

The described protection system also allows an optional short delay after the provision of backup power and before starting the orderly shutdown so that if power has been restored by the end of or during the delay the system can remove the backup power and resume normal operation. This allows operation through momentary outages without instituting an orderly shutdown or affecting operation.

### FIGURES

FIG. 1 shows a simplified example of the states of the state machine and the transitions between states.

FIG. 2 shows one preferred implementation using a power over Ethernet (POE) primary power source.

### DETAILED DESCRIPTION

The following discussion is to be viewed with reasonable extensions as can be seen by those familiar with the art. For example, a reference to a protected processor system will by implication cover a multiprocessor system, and a voltage regulator could encompass step-up, step-down, switching and linear regulators and much more.

This processor protection system entails several components:
1. A normal protected processor system power supply with a means for disconnecting this power supply from the protected processor system to allow the processor protection system to remove all power from the protected processor system.
2. An independent backup power supply with a shutdown means to disconnect the protected processor system from this independent backup power supply. Preferably when not disconnected the backup power automatically prevents the voltage on the protected processor system from falling below its operational range. This avoids or minimizes glitches in the transfer of power sourcing from the normal protected processor system power supply to the backup power supply, and avoids the necessity for detection of failure of the normal protected processor system power supply and rapid activation of the backup power supply.
3. A means for detecting that the normal protected processor system power supply is failed, failing or about to fail. This could be, for example, a monitor of input power or a determination that the backup power supply is sourcing power to the protected processor system. In order not to affect operation of the protected processor system through momentary power glitches a delay and retesting of the detection can be made before the state machine acts on a continuation of the detected failure. This power monitor is said to be “TRUE” when power is detected and “FALSE” when no power is detected.
4. A state machine to control the processor protection system.
5. Two-way communication between the state machine and the protected processor. Signals to be exchanged include a warning from the processor protection system that power is about to fail, acknowledgment from the protected processor that an orderly shutdown is completed, and other control signals as will be described.

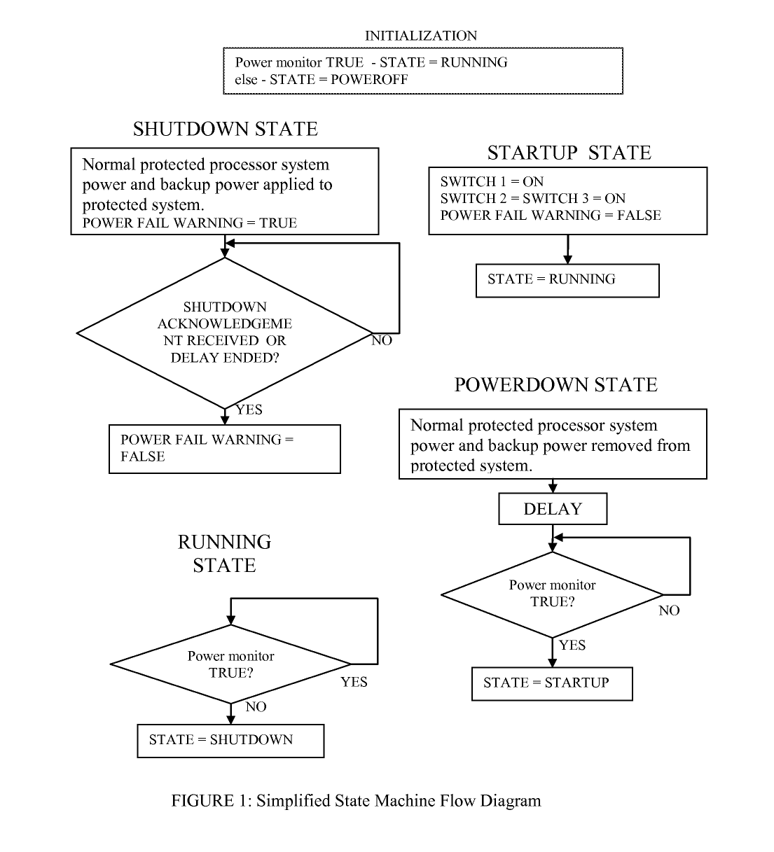

The function of the state machine is to maintain at least four states and to transition between states as shown in FIG. 1. The states and transitions are as follows:
1. RUNNING STATE—This is the normal operation of the processor as if there were no processor protection system. The normal protected processor system power supply is operating normally and its normal output voltage is higher than the output voltage of the backup power supply so that the backup power supply supplies negligible power to the protected processor system. On detection that the normal protected processor system power supply is failed, failing or about to fail (and after any delayed confirmation that failure persists) the state machine transitions to the SHUTDOWN STATE.
2. SHUTDOWN STATE—In this state a signal (POWER FAIL WARNING) is sent to the protected processor. The protected processor initiates an orderly shutdown and after the completion of the orderly shutdown returns a signal (SHUTDOWN COMPLETE) to the state machine. After receiving the SHUTDOWN COMPLETE signal, or after a timeout period sufficiently long that the orderly shutdown should have completed, whichever is shortest, the state machine transitions to the POWERDOWN STATE.
3. POWERDOWN STATE—In this state the state machine removes all power to the protected processor system from both the normal protected processor system power supply and from the backup power supply. The state machine remains in this state for a time sufficient for a complete shutdown of the protected processor system, including sufficient discharge of any capacitors. The state machine then waits on the monitor detecting that the normal protected processor system power supply is failed, failing or about to fail and on a determination that the normal protected processor system power supply is no longer failed, failing or about to fail the state machine transitions to the STARTUP STATE.
4. STARTUP STATE—In this state a startup sequence is initiated. In the simplest case the normal protected processor system power supply are returned to the running state. Any additional steps, such as holding the protected processor system in reset until the power is fully restored are accomplished in this state. At the completion of the startup sequence the state machine transitions to the RUNNING STATE.

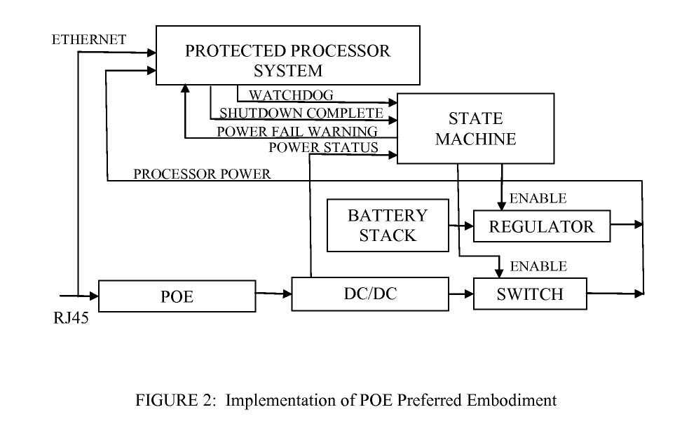

Let us describe a preferred embodiment. This system was originally designed for a power-over-Ethernet (POE) powered system. As shown in FIG. 2, a processor to be protected is powered from a POE with input over a CAT5 or CAT6 cable to a RJ45 connector where the Ethernet signal is separated from the power, which becomes the source of the normal protected processor system power supply. The POE powered device (PD) controller accomplishes the handshaking with the POE injector, using, for example, the IEEE 802.3af protocol. The power is transmitted to a DC-DC converter to supply and to isolate power to the protected processor. Under the IEEE 802.3af protocol if the input voltage drops below 30.5 Volts the POE PD Interface controller is to stop operation. This can be detected and a POWER STATUS signal shown in FIG. 1 is sent to the state machine. In this preferred application the failure of the POE injector power causes the POE controller to shut down the DC converter causing the cessation of activation of the converter's isolation transformer. The isolation transformer's secondary signal is clamped to logic levels and fed to the state machine. The cessation of this signal signals to the state machine that input power has been removed. The POE failure can also be detected by the drooping of the output voltage of the DC-DC converter or by monitoring the POE input voltage. In order to allow the removal of all power to the protected processor system a means for shutting down this POE power must be provided. This can be accomplished by a switch on the output of the DC-DC converter controlled by the state machine. An example of such a switch is the TPS22910 from Texas Instruments, which has the ability of isolating the POE power from the protected system and the additional advantage of limiting feedback from the protected system into the POE power source. Alternatively, if the POWER STATUS is obtained from the POE input power, the POE power can be removed by shutting down the POE PD interface. This gated POE power then represents the normal protected processor system power supply discussed above.

In this preferred embodiment there is included in the protection system a set of batteries to provide the source for the backup power system. The batteries feed a low-dropout-voltage regulator with an enable function, such as the Texas Instruments TPS7A4501. The enable function of the regulator provides a means for disconnecting the batteries from the protected processor system in the POWER-DOWN STATE, and the TPS7A4501 has the additional advantage of preventing any backfeeding from the power input to the protected system when a shorted battery cell reduces the battery voltage below the POE output voltage. The TPS7A4501 is an adjustable regulator and if its output voltage is adjusted to be slightly below the voltage of the normal protected processor system power supply (but still within the operating range of the protected processor system), then when the normal protected processor system power supply is operating the regulator will be effectively off and the battery disconnected from the normal protected processor system power supply. Since the normal protected processor system power supply can be capacitively decoupled with a relatively large capacitance, the switchover from the normal protected processor system power supply to the backup power is automatic and causes very little droop or dropout. The use of rechargeable batteries allows charging of the batteries from the normal protected processor system power supply when it is operating.

When this preferred embodiment is in the RUNNING STATE the POWER STATUS indicates that the POE power is present and the protected processor system is run from the POE power at a voltage that effectively isolates the backup battery due to the lower voltage regulator voltage. On a failure of the POE power the backup battery voltage regulator will automatically turn on when the protected processor system voltage falls to the backup voltage regulator voltage and the protected processor will be powered from the backup power. At this point there is no urgency in detecting the failure of the input power so any delay in the detection of this failure by monitoring the POWER STATUS will not be detrimental. In the preferred embodiment the POWER STATUS is tested over period of time (a glitch delay) and the state machine only transitioning to the SHUTDOWN STATE if the POWER STATUS indicates power has not been restored during that period of time, otherwise the RUNNING STATE is maintained and the POWER STATUS is continued to be normally monitored. This avoids entering the SHUTDOWN STATE during power glitches while assuring no glitch to power to the protected processor system.

If the POWER STATUS after any glitch delay testing has been determined to indicate failure of the POE power and the state machine transitions to the SHUTDOWN STATE this initiates a process leading to the irreversible shutdown and cold start, even if POE power is restored during the system during this process. The state machine remains in this SHUTDOWN STATE for the shutdown time, which is either until the protected processor indicates that the orderly shutdown has completed (SHUTDOWN COMPLETE signal) or a predetermined time has elapsed to indicate that the shutdown procedure has hung. In either event the state machine turns off and transitions into a POWERDOWN STATE.

As described previously there are conditions that the protected processor can detect or that can be externally detected that may require a hard reset to rectify. On the detection of such conditions the protection system can be signalled to provide the same shutdown and transition to SHUTDOWN STATE from the RUNNING STATE as if the POWER FAIL WARNING had indicated an incipient power fail. This is referred to as simulating the indication that the external power is failing and when a hard reset is desired can be triggered by a signal from the protected processor or other protected processor source, or can be triggered by appropriate manipulation of the SHUTDOWN COMPLETE signal.

The POWERDOWN STATE is maintained for a fixed period of time even if the input power has restarted. This insures the complete shutdown of the protected processor and avoids indeterminate operation often seen with momentary power removal where the system capacitance either does not completely drain to the point where a power-on restart is initiated or drains to the point where the system operation is unreliable before returning to normal values. After the fixed period of time insuring a subsequent clean cold startup has expired, the state machine then monitors the POWER STATUS signal looking for indication that power has been restored.

If it is determined that power has been restored the state machine transitions from the POWERDOWN STATE to the STARTUP STATE where a defined startup sequence is performed to result in the protected processor system being run from the POE power at a voltage that effectively isolates the backup battery due to the lower voltage regulator voltage. The startup sequencing can be specific to a particular system but as an example of a startup sequence, in practice it has been found that some systems are sensitive to the rate at which the power voltage is applied, with a slowly-rising input voltage resulting in unreliable operation. Holding the protected system in reset during the ramp-up of the system voltage and then releasing the system reset has been found to avoid this power ramp-up sensitivity. At the completion of the STARTUP STATE the state machine transitions to the RUNNING STATE.

In this preferred embodiment the state machine is a MSP430G2211IPW14 processor powered from the backup power system batteries. The MSP430G2211IPW14 is capable of microAmpere operation to reduce battery drain in the case of protracted operation without POE power.

This preferred embodiment includes a signal (WATCHDOG) from the protected processor system to the state machine allowing it to perform the functions of a watchdog timer to replace or augment the protected processor's system reset. During the RUNNING STATE should there not be a timely toggling of this WATCHDOG the state machine responds to this in the same way as if it detects a failure of the POE system, and proceeds to transition from the RUNNING STATE to the SHUTDOWN STATE. In the preferred embodiment a rapid cycling of WATCHDOG causes this same transition to provide the protected processor system a means to trigger a hard reset when conditions are encountered that may not be resolved by a processor reset or if the watchdog is being triggered in a tight loop. Both methods of triggering the transition to the SHUTDOWN STATE are referred to as “simulating the indication that the external power is failing”.

The BACK-UP POWER block can be implemented in a number of ways. The simplest is the use of batteries, as was done in the preferred embodiment. For example if the system power is 5 Volts, the use of four NiMH batteries in series will give a nominal 4.8 Volts. The NiMH batteries can be trickle-charged from the norm al externally-supplied power supply (POE in the preferred embodiment) through a charge pump or other charging systems can be implemented for extended life. As an alternative to this higher voltage battery and step-down regulator, a lower voltage battery or capacitor storage can be used with a step-up regulator with enable (such as the Maxim MAX8815) providing the backup power. Alternatively since the function of the POWERDOWN STATE is to wait for the restoration of external power the state machine can have a no-power state that insures input and backup power sources are disconnected from the protected processor system and have its power supplied from the external power source with some power holdup only during the shutdown period. Otherwise if a capacitor storage (e.g. a supercap) is used, a secondary battery may be required to power the state machine during the protection system's SHUTDOWN and POWERDOWN STATE.

Alternatively, the POE block and/or the DC-DC converter can be replaced by any other power source providing normal power to the protected processor. With any power system either a power fail warning can be created or the output power can be monitored to provide the POWER STATUS signal to initiate transitions of the state machine.

There are a number of ways for determining that external power to a protected processor is failing or is about to fail, initiating the exit from RUNNING STATE. One possibility is driving power to the system power supply (POE injector, AC or DC supply voltage) can be monitored to provide an indication that loss of power is imminent. Another possibility is the voltage to the protected processor can be monitored and a power failure indicated by a falling voltage.

We claim:

1. A method of protecting a processor system by the use of a state machine to control a the shutting down of power and the restoration of power comprising the steps of:
a. providing a means for supplying a backup power source, and
b. providing a means for selectively supplying power to said protected processor system from said backup power source, from the normal external power source, from both power sources, or from neither, and
c. providing a means for determining that external power to a protected processor is failed, failing or is about to fail, and
d. providing a means for shutdown signaling to said protected processor that shutdown is imminent on said indication that the external power is failed, failing or about to fail to allow said processor to begin an orderly shutdown, and
e. providing provision within the code of said protected processor for conducting an orderly shutdown of said protected processor, and
f. providing a means for receiving from said protected processor an indication that said orderly shutdown is complete after said shutdown signaling, and
g. providing a means for removing power from said protected processor on receipt of said indication that said orderly shutdown is complete or that a predetermined time has elapsed after said shutdown signaling without said indication that said orderly shutdown is complete, and
h. providing a means after said removing power from said protected processor for a fixed time for determining that said external power has been restored, and
i. providing a means for orderly restoring power to said protected processor after said determination that said external power has been restored,
whereby said protected processor is protected against unsafe operation.

2. The method of protecting a processor system of claim 1 wherein said providing a means for selectively supplying power to said protected processor system from said backup power source comprises a means for maintaining a minimum voltage at said protected processor system in a manner that can be turned off and providing a means whereby power is not drawn from said backup power source when said normal external power source is operating.

3. The method of protecting a processor system of claim 1 wherein said providing a means for selectively supplying power to said protected processor system from said backup power source, from the normal external power source, from both power sources, or from neither comprises providing a switch between either said power source and said protected processor system power.

4. The method of protecting a processor of claim 1 further including providing a means for simulating said indication that the external power is failing in response to a request signal from said protected processor system or other source in order to provide a hard reset to said protected processor system.

5. The method of protecting a processor of claim 1 wherein said backup power source includes a battery or a charged capacitor together with a voltage regulator.

6. The method of protecting a processor of claim 1 further including providing a means for monitoring a watchdog signal from said protected processor and responding to the failure to timely receive said watchdog signal in the same manner as if there were an indication that the external power is failed, failing or about to fail.

7. The method of protecting a processor of claim 1 wherein said indication that the external power is failed, failing or is about to fail includes a delay between first detection of such indication and declaration of said indication so that there is no declaration of said indication in the event that external power is restored during said delay.

8. The method of protecting a processor of claim 1 wherein said providing a means for orderly restoring power to said protected processor comprises the application of power to said protected processor system while said protected system is held in reset and after a delay releasing said reset while maintaining power.

9. A machine for protecting a processor system comprising:
a. a normal protected processor system power supply with a means for disconnecting said normal power supply from said protected processor system, and
b. a backup power supply capable of maintaining a switchable power to said protected processor system in a manner such that said backup power source is not drained while said normal protected processor system power supply is operating in a normal fashion, and
c. a power supply monitor capable of determining if said normal protected system power supply power is failed, failing or about to fail, and
d. a state machine with at least the following states and state transitions:
i. a startup state where said normal protected processor system power supply and said backup power supply are turned on in a controlled manner after which the running state is entered, and
ii. a running state where said normal protected processor system power supply and said backup power supply are on, and transitioning to the shutdown state occurs when said monitor of said protected system power supply determines said protected system power supply power is failed, failing or about to fail, and
iii. a shutdown state where at least the following steps are taken:
1. said backup power supply remains on, and
2. an irreversible shutdown handshaking sequence between said state machine and said protected processor system is initiated comprising the following steps:
a. said state machine signals said protected processor that a power shutdown is imminent, and
b. after an orderly shutdown said protected processor signals said state machine that said protected processor has completed an orderly shutdown, and
c. after receipt of said signal that said protected processor has completed an orderly shutdown, or a defined period has passed from said state machine signaling said protected processor that a power shutdown is imminent the state machine turns off both said normal protected processor system power supply and said backup power supply, and after a predetermined time the state machine transitions to the powerdown state, and
iv. a powerdown state where both said normal protected processor system power supply and said backup power supply are off and the state machine monitors said protected system power supply monitor to determine that said protected system power supply is no longer failed or failing, in which case said state machine transitions to said startup state, whereby said protected processor is protected against premature shutdown.

10. The machine for protecting a processor system of claim 9 wherein the backup power supply capable of maintaining a switchable power to said protected processor system comprises a power source combined with a switch or a switchable regulator.

11. The method of protecting a processor system of claim 9 wherein said protected processor system power supply with a means for disconnecting said normal power supply from said protected processor system comprises a switch or switchable regulator between a power supply and said protected processor system.

12. The method of protecting a processor system of claim 9 further including an input signal to said state machine to trigger a transition from said running state to said shutdown state to allow forcing a hard reset from the running state.

13. The backup power source of claim 9 wherein said backup power source includes a battery, a charged capacitor or a voltage regulator.

14. The running state of claim 9 further including monitoring a watchdog signal from said protected processor during said running state and responding to the failure to timely receive said watchdog signal in a timely manner by transitioning from said running state to said shutdown state.

15. The running state of claim 9 further including a delay before transition to said shutdown state caused by said power supply monitor indicating failure of monitored power and aborting said transition if said power supply monitor indicates restoration of monitored power during said delay.
